(19) United States
(12) Patent Application Publication
(10) Pub. No.: US 2004/0025077 A1
(43) Pub. Date: Feb. 5, 2004

(54) Method and apparatus for the dynamic tuning of recovery actions in a server by modifying hints and symptom entries from a remote location

(75) Inventor: Hany A. Salem, Pflugerville, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/210,361

(22) Filed: Jul. 31, 2002

(51) Int. Cl. G06F 11/36

(52) U.S. Cl. 714/2

(57) ABSTRACT

The present invention relates to a method, apparatus, and computer instructions for dynamic tuning of recovery actions in a server by modifying hints and symptom entries from a remote location. A runtime error controller receives an incident, which is compared with other incidents in the local cache of rules from a knowledge base. The knowledge base contains hints and symptom entries, which describe specifics of an incident and the data to collect. If the incident is matched, dynamic tuning information for the incident is retrieved and diagnosed to determine the recovery actions for the incident. Recovery actions are invoked to capture data, dump data structures, and return control to the runtime server. The data that has been captured or dumped is logged for future analysis. The hints and symptom entries in the knowledge base may be modified, expanded and fine-tuned with experience over time.

### CROSS REFERENCE TO RELATED APPLICATIONS

The present invention is related to applications entitled “FIRST FAILURE DATA CAPTURE”, attorney docket number AUS920020322US1, which was filed Jul. 11, 2002, assigned to the same assignee, and incorporated herein by reference.

### BACKGROUND OF THE INVENTION

1. Technical Field

The present invention relates to an improved data processing system. In particular, the present invention relates to a method, apparatus, and computer instructions for the dynamic tuning of recovery actions in a server by modifying hints and symptom entries from a remote location.

2. Description of Related Art

One of the most difficult tasks to accomplish during data capture and runtime recovery is programming a server or runtime to accommodate all situations. While designers always attempt to predict situations ahead of time and program server runtime to accommodate these situations, time and time again it is discovered that new situations or incidents are encountered which were not handled by the runtime code. The classic technique of remedies involves preprogramming of recovery logic, which involves runtime code changes. Current technology requires software maintenance on deployed systems, which is an unattractive and costly enterprise. Often customers need to be able to reproduce the problem and enable tracing to locate the error that occurred.

Normally, component recovery looks for certain failures and decides, after analysis, which data artifacts to capture for problem analysis and recovery.

The classic data collection and error recovery schemes involve programmatic changes, which cause both runtime destabilization and enterprise reluctance for frequent software updates. The normal procedure, for enterprises to perform software updates to correct problems, costs the customer both valuable time and money.

Therefore, it would be advantageous to have an improved method, apparatus, and computer instructions for dynamically tuning recovery actions in a server without making runtime code changes.

### SUMMARY OF THE INVENTION

The present invention relates to a method, apparatus, and computer instructions for dynamic tuning of recovery actions in a server by modifying hints and symptom entries from a remote location. A runtime error controller receives an incident, which is compared with other incidents in the local cache of rules from a knowledge base. The knowledge base contains hints and symptom entries, which describe specifics of an incident and the data to collect. If the incident is matched, dynamic tuning information for the incident is retrieved and diagnosed to determine the recovery actions for the incident. Recovery actions are invoked to capture data, dump data structures, and return control to the runtime server. The data that has been captured or dumped is logged for future analysis. The hints and symptom entries in the knowledge base may be modified, expanded and fine-tuned over time and with experience. Additionally, the hints and symptom entries may be maintained remotely and by a service provider.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 illustrates a block diagram of a data processing system in which the present invention may be implemented;

FIG. 4 is a block diagram of the process to capture data using directives when an incident occurs in accordance with a preferred embodiment of the present invention;

FIG. 5 is a block diagram illustrating the process for refreshing the local cache of the knowledge base used by the log analysis engine in accordance with a preferred embodiment of the present invention;

FIG. 6 is a flowchart of the process for incident handling using dynamic tuning information or directives in accordance with a preferred embodiment of the present invention;

FIG. 7 is a flowchart of the process for updating the local cache of rules created from the knowledge base in accordance with a preferred embodiment of the present invention; and

FIG. 8 is a flowchart of the process for updating the local cache of rules with the current version of the knowledge base in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

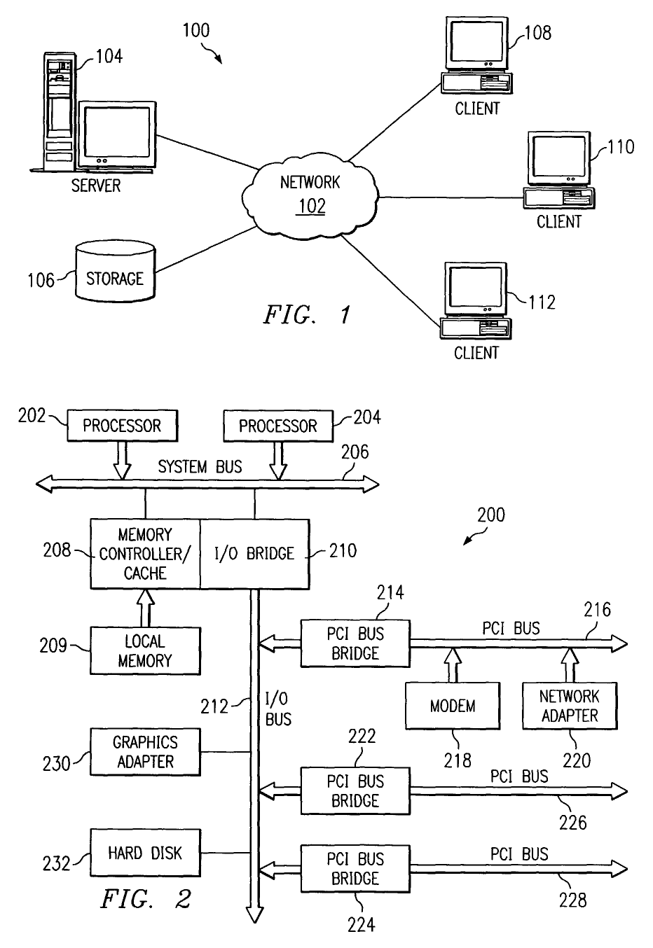

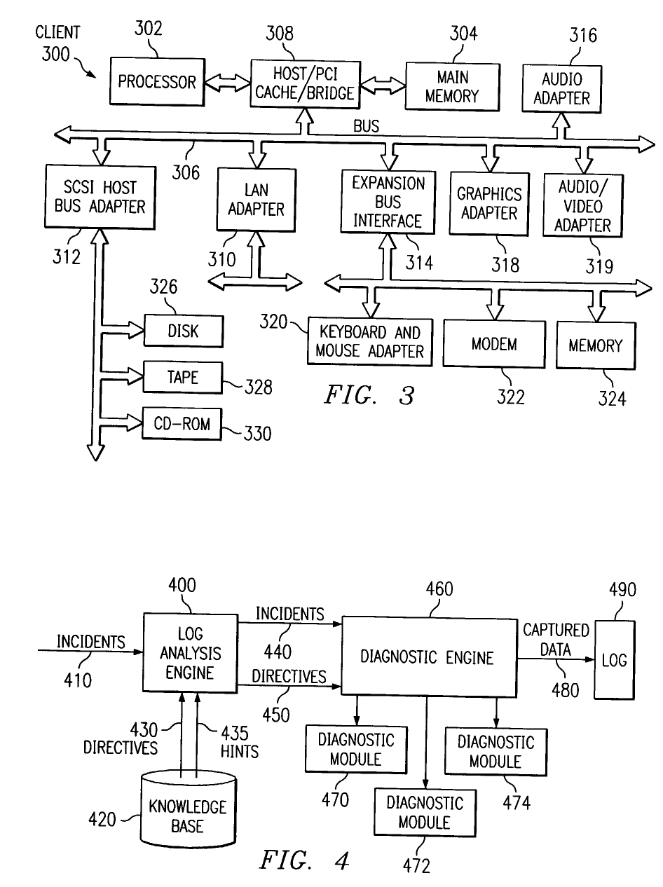

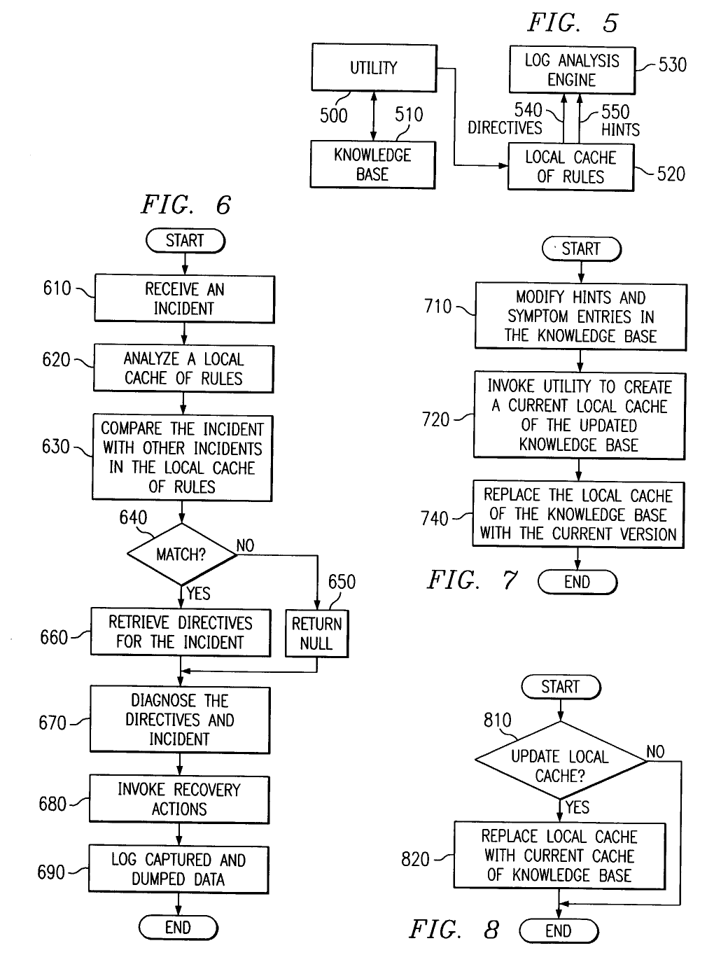

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. In a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a block diagram of the process to capture data using directives when an incident occurs in accordance with a preferred embodiment of the present invention. A directive is dynamic tuning information for incident handling. A directive specifies which diagnostic module should be executed for a given incident. An incident may be, for example, a problem, a runtime error, a failure, or an unhandled situation in runtime program code.

Log analysis engine 400 is a rule-based engine. Log analysis engine 400 receives incident 410, which may be for example tire balance problem on an automobile. Log analysis engine 400 compares incident 410 against a set of known incidents located in the local cache of rules for knowledge base 420. For example, previous customers may have experienced the tire balance problem and the hints and symptoms for the tire balance problem may be stored in local cache of rules for knowledge base 420. The hints and symptom entries in knowledge base 420 provide information associated with various incidents.

A symptom is data that uniquely identifies an incident, such as for example, a message number, a call stack, or a Structured Query Language (SQL) code. A hint is output text that provides the descriptive association between the incident and the cause. A hint describes the recovery action for the user, which may be displayed to the user. The hints and symptom entries can be updated, expanded, and fine-tuned over time based on experience and independent of programmatic changes to the runtime. The hints and symptoms entries can be owned and maintained by a software provider. If, for example, a computer system, such as for example, server 104 and client 108, 110, and 112 in FIG. 1, using the present invention contains the application WebSphere, the computer system can access the hints and symptom entries maintained by the software provider for WebSphere remotely outside the enterprise.

If incident 410 is matched against the set of known incidents, the associated directives and hints, such as for example, directives 430 and hints 435, are returned as a string array. The last entry in the array is the message or associated text that is normally displayed by log analysis engine 400. If incident 410 is not matched, null is returned.

Incident 440 and directives 450 assist diagnostic engine 460 in customizing the data that is logged. Directives 450 describe the data to collect for incident 440 in terms of function or method names, such as the names for diagnostic modules 470, 472, and 474. Diagnostic engine 460 uses directives 450 to select the diagnostic modules, such as for example diagnostic modules 470, 472, and 474, which gather data as the incident occurs and potentially fix a problem.

Diagnostic modules 470, 472, and 474 are components, which can list data artifacts, such as data structures, simple recovery actions, and modularize programs to collect and perform one at a time. The binding is only made at the most primitive level. So, for example, function dumpA( ), simply dumps data artifact A, no more and no less, so on and so forth. Diagnostic engine 460 sends captured data 480 to log 490.

FIG. 5 is a block diagram illustrating the process for refreshing the local cache of the knowledge base used by the log analysis engine in accordance with a preferred embodiment of the present invention. Utility 500 is invoked to refresh or replace the local cache of a knowledge base or repository, such as for example, knowledge base 510 or knowledge base 420 in FIG. 4, when a repository resource is updated, such as for example, hints and symptom entries in knowledge base 510. Additionally, utility 500 may be invoked by a user or at specified time intervals to receive the latest data capturing information for specific incidents occurring on a computer system.

Utility 500 creates local cache of rules 520 using the current version of knowledge base 510. The newly created local cache of rules replaces any previous version of the local cache of rules for the knowledge base. When local cache of rules 520 is updated, log analysis engine 530 receives directives and hints, such as directives 540 and hints 550, which provides the latest data capturing information for a given incident.

FIG. 6 is a flowchart of the process for incident handling using dynamic tuning information or directives in accordance with a preferred embodiment of the present invention. A runtime error controller, such as for example log analysis engine 400 in FIG. 4, receives an incident (step 610). A local cache of rules from a knowledge base is analyzed (step 620). The incident is compared with other incidents in the local cache of rules (step 630). A determination is made as to whether the incident is matched in the local cache of rules (step 650). If the incident is not matched, null is returned in a string array (step 650) and the process continues with step 670. If the incident is matched, directives or dynamic tuning information for the incident are retrieved in a string array (step 660). The incident and directives are diagnosed to determine the recovery actions for the incident (step 670). The recovery actions are invoked to capture data, dump data structures, and return control to the runtime server (step 680). The data that has been captured or dumped is logged (step 690) with the process terminating thereafter.

FIG. 7 is a flowchart of the process for updating the local cache of rules created from the knowledge base in accordance with a preferred embodiment of the present invention. System administrators modify hints and symptom entries (step 710) in the knowledge base. Hints and symptom entries may be maintained remotely from the present invention. Additionally, service providers may maintain the hints and symptom entries. Hints and symptom entries in the knowledge base may be updated, expanded, and fine-tuned over time and with experience to describe the specifics of an incident and data to collect.

A utility is invoked to create a new local cache of rules from the updated knowledge base (step 720). The current local cache of rules is replaced with the new version (step 730) with the process terminating thereafter.

FIG. 8 is a flowchart of the process for updating the local cache of rules with the current version of the knowledge base in accordance with a preferred embodiment of the present invention.

A determination is made as to whether to update the local cache of rules from the knowledge base (step 810). If the local cache of rules is not to be updated the process terminates. A user may select to update the local cache of rules by pressing a button. Additionally, the update may be driven by a specified schedule or by changes occurring in the knowledge base. If the local cache of rules is to be updated, the local cache of rules is replaced by a new local cache of rules create from the current version of the knowledge base (step 820) with the process terminating thereafter.

Thus, the present invention provides an improved method, apparatus, and computer instructions for dynamic tuning of recovery actions in a server by modifying hints and symptom entries from a remote location. The isolation layer provided by the method of the present invention separates the task of updating recovery actions and data collection artifacts from programmatic changes by allowing for these actions to be maintained and fine-tuned at a remote location. The present invention reduces the need for enterprises to perform software updates to runtime code, which provides more stability to the runtime and saves both time and money.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for dynamically tuning recovery actions in a server, the method comprising:
retrieving dynamic tuning information from a local cache of rules for decision making;
updating the local cache of rules for decision making based on hints and symptom entries in a knowledge base to form an updated local cache of rules for decision making;
receiving an incident by a runtime error controller; and
analyzing the updated local cache of rules for decision making to determine a recovery action for the incident.

2. The method of claim 1, wherein the incident is at least one of a problem, a runtime error, a failure, and an unhandled situation in a program.

3. The method of claim 1, wherein the hints and symptom entries in the knowledge base identify the incident and dynamic tuning information associated with the incident.

4. The method of claim 1, wherein the recovery actions are at least one of capturing data, dumping data, and returning control to the server.

5. The method of claim 4, wherein the captured data is logged.

6. The method of claim 4, wherein the dumped data is logged.

7. The method of claim 1, wherein the updating step is based on a specified time interval.

8. The method of claim 1, wherein the updating step is based on discovering changes to the hints and symptom entries in the knowledge base.

9. The method of claim 1, wherein a system administrator maintains the hints and symptom entries in the knowledge base.

10. The method of claim 1, wherein a service provider maintains the hints and symptom entries in the knowledge base.

11. The method of claim 9, wherein the hints and symptom entries in the knowledge base are maintained remotely.

12. The method of claim 1, wherein the analyzing step is performed by a rule based engine.

13. A data processing system comprising:
a bus system;
a communications unit connected to the bus system;
a memory connected to the bus system, wherein the memory includes as set of instructions; and
a processing unit connected to the bus system, wherein the processing unit executes the set of instructions to retrieve dynamic tuning information from a local cache of rules for decision making; update the local cache of rules for decision making based on hints and symptom entries in a knowledge base to form an updated local cache of rules for decision making; receive an incident by a runtime error controller; and analyze the updated local cache of rules for decision making to determine a recovery action for the incident.

14. A data processing system for dynamically tuning recovery actions in a server, the data processing system comprising:
retrieving means for retrieving dynamic tuning information from a local cache of rules for decision making;
updating means for updating the local cache of rules for decision making based on hints and symptom entries in a knowledge base to form an updated local cache of rules for decision making;
receiving means for receiving an incident by a runtime error controller; and
analyzing means for analyzing the updated local cache of rules for decision making to determine a recovery action for the incident.

15. A computer program product in a computer readable medium for dynamically tuning recovery actions in a server, the computer program product comprising:
first instructions for retrieving dynamic tuning information from a local cache of rules for decision making;
second instructions for updating the local cache of rules for decision making based on hints and symptom entries in a knowledge base to form an updated local cache of rules for decision making;
third instructions for receiving an incident by a runtime error controller; and
fourth instructions for analyzing the updated local cache of rules for decision making to determine a recovery action for the incident.
